(19) United States
(12) Patent Application Publication
(10) Pub. No.: US 2023/0184983 A1
(43) Pub. Date: Jun. 15, 2023

(54) VECTOR-RESISTIVITY-BASED REAL-TIME ADVANCED DETECTION METHOD FOR WATER-BEARING HAZARD BODY

(71) Applicant: CHINA UNIVERSITY OF MINING AND TECHNOLOGY, Jiangsu (CN)

(72) Inventors: Zhihai JIANG, Jiangsu (CN); Jianhua YUE, Jiangsu (CN); Shucai LIU, Jiangsu (CN); Shaoqing WANG, Jiangsu (CN); Maofei LI, Jiangsu (CN); Zhaofeng GAO, Jiangsu (CN); Wenchuang WANG, Jiangsu (CN)

(21) Appl. No.: 17/924,736

(22) PCT Filed: Apr. 2, 2022
(86) PCT No.: PCT/CN2022/085060

§ 371 Date: Nov. 11, 2022

(30) Foreign Application Priority Data
Apr. 20, 2021 (CN) 202110425736.3

(51) Int. Cl. G01V 3/04; G01V 3/12

(52) U.S. Cl. CPC G01V 3/04; G01V 3/12

(57) ABSTRACT

The present disclosure relates to a method for advancedly detecting a water-bearing hazard body in real-time based on vector resistivities. The method includes: acquiring potential differences of receiving dipoles on a shield machine in real-time based on a pre-constructed detection environment, wherein the receiving dipoles include first receiving dipoles and a second receiving dipole; converting to resistivities by using a formula for calculating resistivities in a steady current field according to relative positional relationships between the receiving dipoles and power supply dipoles and the potential differences of the receiving dipoles to obtain the apparent resistivities of the receiving dipoles; drawing curves of the apparent resistivities of the receiving dipoles by taking positions of the power supply dipoles as an abscissa axis and the apparent resistivities as an ordinate axis; analyzing the changing curves of the apparent resistivities and determining a detection result of an abnormal body. According to this method, in the process of a continuous underground tunneling of the shield machine, the conditions of the water-bearing hazard body in front of the tunneling is detected in real-time by means of continuously receiving electric signals by the receiving dipoles and drawing the curves of the apparent resistivities of the receiving dipoles, thereby improving the real-time performance of the advanced prediction results.

### TECHNICAL FIELD

The present disclosure relates to the technical field of tunnel engineering, and in particular to a method for advancedly detecting a water-bearing hazard body in real-time based on vector resistivities.

### BACKGROUND

At present, in order to solve the problem of urban traffic congestion, subway traffic has begun to be built on a large scale in China. In the process of tunneling subway tunnels, the technology for advancedly detecting tunnels must be adopted to detect, to do an advanced prediction of unfavorable geological bodies, so as to prevent occurrences of the disasters such as water inrush and mud gushing.

The technology for advancedly detecting tunnels includes an advanced drilling method, a geological radar method, a DC resistivity method, an infrared detection method, electromagnetic methods and a seismic wave method, and the like. In view of the actual requirements on a tunnel advanced detection, two or more technical methods usually be adopted for a comprehensive detection. However, each of the methods has its applicable scope and certain disadvantages. The advanced drilling method is the most direct and accurate method in all of the detection technologies, and it is extremely expensive and time-consuming. An advanced drilling in front of a tunnel face needs to hit the drill bit to an abnormal area at a fixed angle. Factors such as rock hardness and fluid will have a great impact on the drilling progress and the bit direction, which requires extremely high expertise and experience. For a short-term advanced prediction, the geological radar method and the infrared detection method are provided, which have higher detection accuracy for abnormal bodies within 30 m in front of the tunnel. The infrared is sensitive to water, and the geological radar method is capable of reflecting the regional shape and boundary of the abnormal body clearly. For a medium and long-term prediction, that is, within 30-100 m in front of the tunnel face, the DC resistivity method and the electromagnetic methods are provided as common methods, such as a ground high-density DC advanced detection, an underground DC advanced detection, and a tunnel face transient electromagnetic advanced detection. The construction of ground high-density method is relatively complicated and easy to be shielded by a high resistivity layer. The underground DC advanced detection is not so accurate in the interpretation for the anomalies ahead, which is easy to be misinformed. Although the construction of transient electromagnetic method is convenient and rapid, some blind areas exist in the transient electromagnetic method, and the construction of the transient electromagnetic method is easily affected by the underground electromagnetic interference. For a long-term prediction, that is, more than 100 m in front of the tunnel face, the seismic wave method, such as a TSP advanced prediction, is required, the method requires drilling and blasting, the construction of the TSP advance prediction is complex and time-consuming, which may have a certain impact on the geological structure of the tunnel.

Therefore, each of the advanced geophysical detection technologies has its own application conditions and applicable scenario at the present, and they are all in a mode of “prediction before tunneling”, that is, the prediction and construction are separated, which results in a low real-time performance of advanced prediction results.

### SUMMARY

Based on this, in view of the above technical problems, it is necessary to provide a method for advancedly detecting a water-bearing hazard body in real-time based on vector resistivities that can improve the low real-time performance of the advanced prediction results.

Provided is a method for advancedly detecting a water-bearing hazard body in real-time based on vector resistivities, the method includes the following steps.

Potential differences of receiving dipoles on a shield machine are acquired in real-time based on a pre-constructed detection environment, and the receiving dipoles includes first receiving dipoles and a second receiving dipole.

According to relative positional relationships between the receiving dipoles and power supply dipoles and the potential differences of the receiving dipoles, the resistivity conversion is performed by using a formula for calculating resistivities in a steady current field to obtain the apparent resistivities of the receiving dipoles.

Curves of the apparent resistivities of the receiving dipoles are drawn by taking positions of the power supply dipoles as an abscissa axis and the apparent resistivities as an ordinate axis.

The changing curves of the apparent resistivities are analyzed and a detection result of an abnormal body is determined.

A construction method of the detection environment is as follows.

A plurality of power supply electrodes are arranged at a constant interval on a ground along a central axis of a tunnel in a direction of tunneling, and the power supply dipoles are formed by combining each adjacent power supply electrodes pairwise.

A preset number of first receiving electrodes are arranged around the shield machine at a preset interval arc length on a shield machine shell away from a cutterhead of the shield machine. A preset number of second receiving electrodes are arranged around the shield machine at the preset interval arc length on the shield machine shell proximate to the cutterhead of the shield machine. Each of the second receiving electrodes is correspondingly located on an extension line parallel to the shield machine shell in a direction from a location point of a first receiving electrode to the cutterhead of the shield machine.

The preset number of the first receiving dipoles are formed by the first receiving electrodes and the second receiving electrodes on a same extension line. Position points of the second receiving electrodes around the shield machine shell proximate to the cutterhead of the shield machine are connected to each other. The second receiving dipole is formed by two of the second receiving electrodes on a line segment passing through a central axis of the shield machine and perpendicular to the ground. The first receiving electrodes and the second receiving electrodes are configured to collect the electric signals in the tunnel. The potential differences between the first receiving dipoles and the second receiving dipole in different orientations of the tunnel are obtained according to the electric signals.

Power is supplied to the power supply dipoles in turn along with a continuous underground tunneling of the shield machine to form the detection environment, so that the first receiving electrodes and the second receiving electrodes on the shield machine are capable of collecting the electrical signals.

In one embodiment, the step of analyzing the changing curves of the apparent resistivities and determining the detection result of the abnormal body includes the following steps.

It is determined that whether the abnormal body is detected or not according to whether a minimum value occurs in the changing curves of the apparent resistivities.

When the abnormal body is detected, a location of the abnormal body is determined, according to value comparison relationships of values of apparent resistivities and shapes of curves of apparent resistivities of the first receiving dipoles, and abnormal conditions of a curve of an apparent resistivity of the second receiving dipole.

In one embodiment, the formula for calculating the resistivities in the steady current field is

$${ρ}_{S} = k \frac{Δ {U}_{MN}}{I} ,$$

where Δ U_{MN} is a potential difference between a receiving electrode M and a receiving electrode N of a receiving dipole, ρ_{S} is an apparent resistivity of the receiving dipole, k is a pole distribution constant, I is a power supply current of a power supply dipole, M is the number of one receiving electrode of the receiving dipole, and N is the serial number of another receiving electrode of the receiving dipole.

In the above-mentioned method for advancedly detecting a water-cotained hazard body in real-time based on vector resistivities, potential differences of receiving dipoles on a shield machine are acquired in real-time based on a pre-constructed detection environment, wherein the receiving dipoles includes first receiving dipoles and a second receiving dipole; the resistivity conversion is performed by using a formula for calculating resistivities in a steady current field according to relative positional relationships between the receiving dipoles and power supply dipoles and the potential differences of the receiving dipoles to obtain the apparent resistivities of each of the receiving dipoles; curves of the apparent resistivities of the receiving dipoles are drawn by taking positions of the power supply dipoles as an abscissa axis and the apparent resistivities as an ordinate axis; the changing curves of the apparent resistivities are analyzed and a detection result of an abnormal body is determined. According to the method, in the process of a continuous underground tunneling of the shield machine, the conditions of the water-bearing hazard body in front of the tunneling is detected in real-time by means of continuously receiving electric signals by the receiving dipoles and drawing the curves of the apparent resistivities of the receiving dipoles, thereby improving the real-time performance of the advanced prediction results.

### BRIEF DESCRIPTION OF THE DRAWINGS

FIG. 1 illustrates a flow structural diagram of a method for advancedly detecting a water-bearing hazard body in real-time based on vector resistivities in one embodiment.

FIG. 2 illustrates a diagram for constructing a detection environment of the method for advancedly detecting the water-bearing hazard body in real-time based on vector resistivities in one embodiment.

FIG. 3 illustrates a schematic diagram of a simulated detection environment.

FIG. 4 illustrates a potential distribution of a Y-Z section (x=0).

FIG. 5 illustrates a schematic diagram of a curve of potential attenuation of an electrode N4.

FIG. 6 illustrates a schematic diagram of a curve of the resistivities of a receiving dipole M2-N2 when in the right front at different distances.

FIG. 7 illustrates a schematic diagram of a curve of the resistivities of a receiving dipole M4-N4 when in the right front at different distances.

FIG. 8 illustrates a diagram of a comparison between curves of the resistivities of the receiving dipole M2-N2 and the receiving dipole M4-N4 when in the right front at 15 m.

FIG. 9 illustrates a diagram of a comparison between curves of the resistivities of the receiving dipole M2-N2 and the receiving dipole M4-N4 when in the right front at 25 m.

FIG. 10 illustrates a diagram of a curve of resistivity differences between the receiving dipole M2-N2 and the receiving dipole M4-N4 when in the right front at 15 m.

FIG. 11 illustrates a diagram of a curve of resistivity differences between the receiving dipole M2-N2 and the receiving dipole M4-N4 when in the right front at 25 m.

FIG. 12 illustrates a diagram of a comparison between curves of the resistivities of the receiving dipole M2-N2 and the receiving dipole M4-N4 when in the right-side front at 15 m.

FIG. 13 illustrates a diagram of a comparison between curves of the resistivities of the receiving dipole M2-N2 and the receiving dipole M4-N4 when in the left-side front at 15 m.

FIG. 14 illustrates a diagram of a curve of resistivity differences between the receiving dipole M2-N2 and the receiving dipole M4-N4 when in the right-side front at 15 m.

FIG. 15 illustrates a diagram of a curve of resistivity differences between the receiving dipole M2-N2 and the receiving dipole M4-N4 when in the left-side front at 15 m.

FIG. 16 illustrates a diagram of curves of the resistivities of a receiving dipole M1-N1 and a receiving dipole M3-N3 when in the lower-side front at 15 m.

FIG. 17 illustrates a diagram of curves of the resistivities of the receiving dipole M1-N1 and the receiving dipole M3-N3 when in the upper-side front at 15 m.

FIG. 18 illustrates a diagram of curves of the resistivities of the receiving dipole M1-N1 and the receiving dipole M3-N3 when in the right front at 15 m.

FIG. 19 illustrates a diagram of a curve of the resistivities of a receiving dipole M1-M3 when in the right front at 15 m.

FIG. 20 illustrates a diagram of a curve of the resistivities of the receiving dipole M1-M3 when in the lower-side right front at 15 m.

FIG. 21 illustrates a diagram of a curve of the resistivities of the receiving dipole M1-M3 when in the upper-side right front at 15 m.

FIG. 22 illustrates a diagram of curves of the resistivities of the receiving dipole M2-N2 and the receiving dipole M4-N4 when at a specific position.

FIG. 23 illustrates a diagram of a curve of resistivity differences between the receiving dipole M2-N2 and the receiving dipole M4-N4 when at a specific position.

FIG. 24 illustrates a diagram of curves of the resistivities of the receiving dipole M1-N1 and the receiving dipole M3-N3 when at a specific position.

FIG. 25 illustrates a diagram of a curve of the resistivities of the receiving dipole M1-M3 when at a specific position.

### DETAILED DESCRIPTION OF THE EMBODIMENTS

In order to enable the objectives, technical solutions and advantages of the present disclosure to be more clear, the present disclosure will be further clarified below in conjunction with the accompanying drawings and the embodiments. It should be understood that the specific embodiments described herein are only used to illustrate the present disclosure and not to limit the scope of the present disclosure.

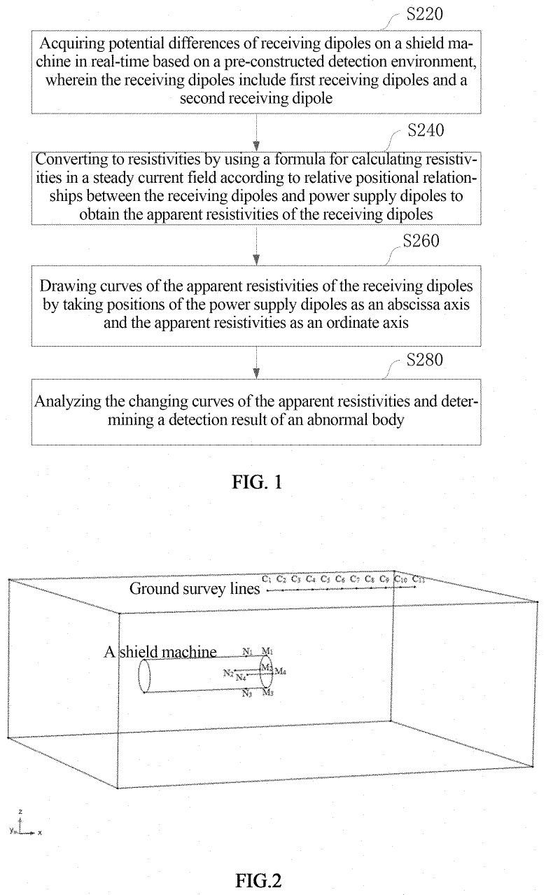

In one embodiment, as illustrated in FIG. 1, provided is a method for advancedly detecting a water-bearing hazard body in real-time based on vector resistivities, which includes the following steps.

In S220, potential differences of receiving dipoles on a shield machine are acquired in real-time based on a pre-constructed detection environment, and the receiving dipoles includes first receiving dipoles and a second receiving dipole.

A construction method of the detection environment is that: a plurality of power supply electrodes are arranged at a constant interval on a ground along a central axis of a tunneling in a direction of tunneling, and the power supply dipoles are formed by combining each adjacent power supply electrodes pairwise. A preset number of first receiving electrodes are arranged around the shield machine at a preset interval arc length on a shield machine shell away from a cutterhead of the shield machine. A preset number of second receiving electrodes are arranged around the shield machine at the preset interval arc length on the shield machine shell proximate to the cutterhead of the shield machine. Each of the second receiving electrodes is correspondingly located on an extension line parallel to the shield machine shell in a direction from a location point of a first receiving electrode to the cutterhead of the shield machine. The preset number of the first receiving dipoles are formed by the first receiving electrodes and the second receiving electrodes on a same extension line. Position points of the second receiving electrodes around the shield machine shell proximate to the cutterhead of the shield machine are connected to each other. The second receiving dipole is formed by two of the second receiving electrodes on a line segment passing through a central axis of the shield machine and perpendicular to the ground. The first receiving electrodes and the second receiving electrodes are configured to collect the electric signals in the tunnel. The potential differences between the first receiving dipoles and the second receiving dipole in different orientations of the tunnel are obtained according to the electric signals. Power is supplied to the power supply dipoles in turn along with a continuous underground tunneling of the shield machine to form the detection environment, so that the first receiving electrodes and the second receiving electrodes on the shield machine are capable of collecting the electrical signals.

The interval distance of the constant interval is determined according to the signal intensities of the first receiving electrodes and the second receiving electrodes on the shield machine. According to pre-tests, when the potential signals received at a certain interval distance in the test is stronger, the abnormal values can be distinguished, and the interval distance of which is taken as the interval distance of the constant interval. In one embodiment, good observation effect can be achieved at the interval distance of 10 m in the tunnel advanced detection.

In one embodiment, according to the location where the stopping head of the tunnel face is located, survey lines are arranged along the projection of the central axis of the tunnel in the direction of tunneling on the ground, the length of the survey line is equal to the distance in front of the tunnel face to be detected, and then a plurality of power supply electrodes (C1, C2, C3 . . . Cn) are arranged on the survey line at a constant interval, the power supply dipoles (C1-C2, C2-C3 . . . Cn-1-Cn) are formed by combining each adjacent power supply electrodes pairwise, and by supplying power to the power supply dipoles, a steady current field of the electric dipole source is established in the medium in front of the tunnel face.

A total of I first receiving electrodes (M1M2M3M4 . . . Mi) are arranged around the shield machine at a preset interval arc length on a shield machine shell away from a cutterhead of the shield machine. A total of j second receiving electrodes (N1N2N3N4 . . . Nj) are arranged around the shield machine at the preset interval arc length on the shield machine shell proximate to the cutterhead of the shield machine. Each of the second receiving electrodes are correspondingly located on an extension line parallel to the shield machine shell in a direction from a location point of a first receiving electrodes to the cutterhead of the shield machine. The preset number of first receiving dipoles (M1-N1, M2-N2, M3-N3, M4-N4, Mi-Nj) are formed by the first receiving electrodes and the second receiving electrodes on the same extension line. Position points of the second receiving electrodes around the shield machine shell proximate to the cutterhead of the shield machine are connected to each other. The second receiving dipole is formed by two of the second receiving electrodes on a line segment passing through a central axis of the shield machine and perpendicular to the ground (Ma-Mb, a is the serial number of a second receiving electrode on the line segment passing through the central axis of the shield machine and perpendicular to the ground, and b is the serial number of another second receiving electrode on the line segment passing through the central axis of the shield machine and perpendicular to the ground). The first receiving electrodes and the second receiving electrodes are configured to collect the electric signals in the tunnel. The potential differences between the first receiving dipoles and the second receiving dipole in different orientations of the tunnel are obtained according to the electric signals.

When the shield machine starts tunneling in the tunnel, the power supply dipole C1-C2 on the ground starts to supply power, and electrical signals are collected by the first receiving electrodes and the second receiving electrodes on the shield machine; after that, C2-C3 starts to supply power, and electrical signals are collected by the first receiving electrodes and the second receiving electrodes on the shield machine; subsequently, C3-C4 starts to supply power, and Cn-1-Cn starts to supply power in turn, the shield machine keeps moving forward, and electrical signals are collected continuously by the first receiving electrodes and the second receiving electrodes on the shield machine.

In one embodiment, the method for acquiring potential differences of the receiving dipoles on the shield machine in real-time includes the following steps.

The collected electrical signals are collected according to the corresponding receiving electrodes that form the receiving dipoles (The receiving electrodes are the first receiving electrodes or the second receiving electrodes. When the receiving dipole is the first receiving dipole, the corresponding receiving electrode includes a first receiving electrode and a second receiving electrode. When the receiving dipole is the second receiving dipole, the corresponding receiving electrode is two second receiving electrodes on the line segment passing through the central axis of the shield machine and perpendicular to the ground.). The potential differences of the receiving dipoles are determined by a formula for calculating the potential differences. The formula for calculating the potential differences is ΔU_{MN}=U_{M}−U_{N}, where ΔU_{MN} is a potential difference between a receiving electrode M and a receiving electrode N of a receiving dipole, U_{M} is the potential of the receiving electrode M of the receiving dipole, and U_{M} is the potential of another receiving electrode M of the receiving dipole.

In S240, according to relative positional relationships between the receiving dipoles and the power supply dipoles, the resistivity conversion is performed by using a formula for calculating resistivities in a steady current field, to obtain the apparent resistivities of the receiving dipoles.

In one embodiment, the formula for calculating the resistivities in the steady current field is:

$${ρ}_{S} = k \frac{Δ {U}_{MN}}{I} ,$$

where ΔU_{MN} is a potential difference between a receiving electrode M and a receiving electrode N of a receiving dipole, ρ_{S} is an apparent resistivity of the receiving dipole, k is a pole distribution constant with a unit of m, I is a power supply current of a power supply dipole, M is the serial number of one receiving electrode of the receiving dipole, and N is the serial number of another receiving electrode of the receiving dipole.

The pole distribution constant k is determined according to the arrangement relationship between the power supply dipoles and the receiving electrodes M and N. A formula for calculating the pole distribution constant k is as follows:

$$k = \frac{2 π}{\frac{1}{AM} - \frac{1}{AN} - \frac{1}{BM} + \frac{1}{BN}} ,$$

where AM is the distance between the power supply electrode A and the receiving electrode M, BM is the distance between the power supply electrode B and the receiving electrode M, AN is the distance between the power supply electrode A and the receiving electrode N, BN is the distance between the power supply electrode B and the receiving electrode N, A is the serial number of one power supply electrode in the power supply dipoles, and B is the serial number of another power supply electrode in the power supply dipoles.

In S260, curves of the apparent resistivities of the receiving dipoles are drawn by taking positions of the power supply dipoles as an abscissa axis and the apparent resistivities as an ordinate axis.

The apparent resistivities are taken as the absolute values to draw the curves of the apparent resistivities of the receiving dipoles.

In S280, the changing curves of the apparent resistivities are analyzed and a detection result of an abnormal body is determined.

In one embodiment, the step of analyzing the changing curves of the apparent resistivities and determining the detection result of the abnormal body includes the following steps.

It is determined that whether the abnormal body is detected or not according to whether a minimum value occurs in the changing curves of the apparent resistivities. When the abnormal body is detected, a location of the abnormal body is determined, according to value comparison relationships of values of apparent resistivities and shapes of curves of apparent resistivities of the first receiving dipoles, and abnormal conditions of a curve of an apparent resistivity of the second receiving dipole.

First, an extreme value of the curves of the apparent resistivities is taken as a basis for determining an abnormal body. When there is a low resistivity abnormal body in front of the tunnel face, a minimum value occurs in the curves of the apparent resistivities, from which a distance between the abnormal body and the tunnel face can be determined. Secondly, according to value comparison relationships of values of apparent resistivities of the first receiving dipoles and shapes of the curves of the apparent resistivities of the first receiving dipoles, and abnormal conditions of a curve of an apparent resistivity of the second receiving dipole, whether the abnormal body is located to the left or to the right in front of the tunneling direction of the shield machine, and whether the abnormal body is located to the upper or to the lower in front of the tunneling direction of the shield machine can be determined, the results of which have a high accuracy.

As illustrated in FIG. 2, provided is the method for advancedly detecting the water-bearing hazard body in real-time based on vector resistivities. The projection of the stopping head of the tunnel face on the ground is taken as the starting point (x=0), a 100 m survey line is arranged along the projection of the central axis of the tunnel on the ground (GPS is used to calibrate the direction orientations of the survey line), which is taken as an example for illustration, and the specific steps are as follows.

A total of 10 power supply electrodes (C1C2C3 . . . C10) are driven point by point at an interval of 10 m on the ground along the central axis of the tunnel in the direction of tunneling. According to the soil conditions on the surface, the total of 10 supply electrodes are driven into the depth of 10 cm to 15 cm, such that the electrical coupling between the power supply electrodes and the surface can be the best. The power supply dipoles (C1-C2, C2-C3 . . . C10-C11) are formed by combining each of the adjacent power supply electrodes pairwise, and then DC power with the power supply current of I=5A is used to supply power to the electrodes, and a steady current field is established underground.

A total of four first receiving electrodes (M1M2M3M4) are arranged around the shield machine at a preset interval arc length on the shield machine shell away from the cutterhead of the shield machine. A total of four second receiving electrodes (N1N2N3N4) are arranged around the shield machine at a preset interval arc length on the shield machine shell proximate to the cutterhead of the shield machine. The second receiving electrode N1 is correspondingly located on an extension line parallel to the shield machine shell in the direction from the location point of the first receiving electrode M1 to the cutterhead of the shield machine, wherein the distance between the second receiving electrode N1 and the first receiving electrode M1 is 10 m. The second receiving electrode N2 is correspondingly located on an extension line parallel to the shield machine shell in the direction from the location point of the first receiving electrode M2 to the cutterhead of the shield machine, wherein the distance between the second receiving electrode N2 and the first receiving electrode M2 is 10 m. The second receiving electrode N3 is correspondingly located on an extension line parallel to the shield machine shell in the direction from the location point of the first receiving electrode M3 to the cutterhead of the shield machine, wherein the distance between the second receiving electrode N3 and the first receiving electrode M3 is 10 m. The second receiving electrode N4 is correspondingly located on an extension line parallel to the shield machine shell in the direction from the location point of the first receiving electrode M4 to the cutterhead of the shield machine, wherein the distance between the second receiving electrode N4 and the first receiving electrode M4 is 10 m.

A total of four first receiving dipoles (M1-N1, M2-N2, M3-N3, M4-N4) are formed by the first receiving electrodes and the second receiving electrodes on the same extension line. Position points of the second receiving electrodes around the shield machine shell proximate to the cutterhead of the shield machine are connected to each other. The second receiving dipole (M1-M3) is formed by two of the second receiving electrodes on the line segment passing through the central axis of the shield machine and perpendicular to the ground. The first receiving electrodes and the second receiving electrodes are configured to collect the electric signals in different directions of the tunnel.

After the shield machine starts to tunneling, the power supply dipole C1-C2 on the ground starts to supply power, and the first receiving electrodes and the second receiving electrodes on the shield machine collect data; After that, the C2-C3 starts to supply power, and the first receiving electrodes and the second receiving electrodes on the shield machine collect data; Subsequently, the C3-C4 starts to supply power, and so on, until the C10-C11 starts to supply power in turn; at the same time, the shield machine continues to move forward, the first receiving electrodes and the second receiving electrodes on the shield machine continuously receive signals and draw the changing curves of the apparent resistivities of the receiving dipoles, so that the real-time and dynamic detection on the abnormal body in front of the tunnel face can be realized.

After the first receiving electrodes and the second receiving electrodes receive the electrical signals, by taking each of the receiving dipoles as a group, the potential difference among each of the groups of the receiving dipoles is calculated, and further the apparent resistivities are calculated according to the potential difference of each of the groups of the receiving dipoles. The apparent resistivities here are converted by adopting the formula for calculating the resistivities in the steady current field based on a uniform half-space model. Because the tunnel model satisfies the conditions of the half-space, the ground enables the receiving of the shield machine. When the shield machine is tunneling in the tunnel, the upper stratum of the tunnel can be regarded as a uniform layered medium.

The formula for calculating the potential differences is ΔU_{MN}=U_{M}−U_{N}, where ΔU_{MN} is the potential difference between the receiving electrode M and the receiving electrode N of the receiving dipole, U_{M} is the potential of one receiving electrode M of the receiving dipole, and U_{M} is the potential of another receiving electrode M of the receiving dipole.

The formula for calculating the resistivities in the steady current field is

$${ρ}_{S} = k \frac{Δ {U}_{MN}}{I} ,$$

where ΔU_{MN} is the potential difference between the receiving electrode M and the receiving electrode N of the receiving dipole, ρ_{S} is the apparent resistivity of the receiving dipole, k is the pole distribution constant with the unit of m, I is the power supply current of the power supply dipole, M is the serial number of one receiving electrode of the receiving dipole, and N is the serial number of another receiving electrode of the receiving dipole.

The pole distribution constant k is determined according to the arrangement relationship between the power supply dipoles and the receiving electrodes M and N. The formula for calculating the pole distribution constant is as follows:

$$k = \frac{2 π}{\frac{1}{AM} - \frac{1}{AN} - \frac{1}{BM} + \frac{1}{BN}} ,$$

where AM is the distance between the power supply electrode A and the receiving electrode M, BM is the distance between the power supply electrode B and the receiving electrode M, AN is the distance between the power supply electrode A and the receiving electrode N, BN is the distance between the power supply electrode B and the receiving electrode N, A is the serial number of one power supply electrode in the power supply dipoles, and B is the serial number of another power supply electrode in the power supply dipoles.

The curves of the apparent resistivities of the receiving dipoles are drawn by taking the positions of the power supply dipoles underground as the abscissa axis and the apparent resistivities (taking the absolute values) as the ordinate axis.

In curves of the apparent resistivities of the receiving dipole M2-N2 or the receiving dipole M4-N4, the extreme value is taken as the basis for determining the abnormal body. When the underground space is uniform without the abnormal body, the curves are only affected by the tunnel and the curves has no extreme value. When there is the low resistivity abnormal body in front of the tunnel face in the tunneling direction of the shield machine, an obvious minimum value will be formed proximate to an abnormal point of the curves. A coordinate value a for the abscissa axis of the minimum value point is the distance of the abnormal body in front of the tunnel face in the tunneling direction of the shield machine.

At the same time, the value comparison relationship of the apparent resistivities values (that is, the values of the apparent resistivities) of the two groups of the receiving dipole M2-N2 and the receiving dipole M4-N4 reflects whether the abnormal body is located to the left or to the right in front of the tunnel face in the tunneling direction of the shield machine. First, the curve between x=0 and x=a is defined as a first curve (that is, an area between the tunnel face and the abnormal body). When the apparent resistivity value for M2-N2 of the first curve is greater than the apparent resistivity value for M4-N4 of the first curve, the abnormal body is located in the left-side front of the tunnel face in the tunneling direction of the shield machine; when the apparent resistivity value for M2-N2 of the first curve is less than the apparent resistivity value for M4-N4 of the first curve, the abnormal body is located in the right-side front of the tunnel face in the tunneling direction of the shield machine; when the apparent resistivity value for M2-N2 of the first curve is equal to the apparent resistivity value for M4-N4 of the first curve, the abnormal body is located in the right-side front of the tunnel face in the tunneling direction of the shield machine.

For a convenient determination, the apparent resistivity of one group of the receiving dipole M2-N2 is subtracted from the apparent resistivity of the other group of the receiving dipole M4-N4 (that is, (M2-N2)−(M4-N4)), and the difference therebetween is taken as a value ρ to draw a curve of differences among the resistivities. At this time, when the curve shows “positive first and then negative”, the abnormal body is located in the left-side front of the tunnel face in the tunneling direction of the shield machine; when the curve shows “negative first and then positive”, the abnormal body is located in the right-side front of the tunnel face in the tunneling direction of the shield machine; when the curve permanently tends to ρ=0 or jumps up and down in a small range around ρ=0, the abnormal body is located in the right front of the tunnel face in the tunneling direction of the shield machine.

In the curves of the apparent resistivities in the two groups of the receiving dipole M1-N1 and the the receiving dipole M3-N3, the morphological characteristics of the first curve formed by two curves are taken as the basis for determining whether an abnormal body is in the upper-side front or in the lower-side front of the tunnel face in the tunneling direction of the shield machine. When the first curve shows the characteristic of “opening” and the changing rate is significantly larger, then the abnormal body is located to the lower in the front of the tunnel face in the tunneling direction of the shield machine; when the first curve shows the characteristic of “parallel”, the abnormal body is located to the upper in the front of the tunnel face in the tunneling direction of the shield machine; when the first curve shows the characteristic of “closed”, the abnormal body is located neither to the upper nor to the lower in the front of the tunnel face in the tunneling direction of the shield machine.

In addition, in the curve of the apparent resistivities of the receiving dipole M1-M3, when an abnormal body located at an upper position of the tunnel face in the tunneling direction of the shield machine has a separate response, which can be taken as an auxiliary parameter outside the curves of the apparent resistivities of the two groups of the receiving dipole M1-N1 and the receiving dipole M3-N3. When the abnormal body is located upper the tunnel face in the tunneling direction of the shield machine, the curve will have a minimum value. For the abnormal bodies at other orientations, the curve of the group of apparent resistivities changes nearly straightly.

In the method for advancedly detecting the water-bearing hazard body in real-time based on the vector resistivities, potential differences of receiving dipoles on the shield machine are acquired in real-time based on a pre-constructed detection environment, wherein the receiving dipoles includes first receiving dipoles and the second receiving dipole; the resistivity conversion is performed by using the formula for calculating the resistivities in the steady current field according to relative positional relationships between the receiving dipoles and power supply dipoles and the potential differences of the receiving dipoles to obtain the apparent resistivities of each of the receiving dipoles; the curves of the apparent resistivities of the receiving dipoles are drawn by taking the positions of the power supply dipoles as the abscissa axis and the apparent resistivities as the ordinate axis; the changing curves of the apparent resistivities are analyzed and the detection result of the abnormal body is determined According to the method, in the process of a continuous underground tunneling of the shield machine, the conditions of the water-bearing hazard body in front of the tunneling is detected in real-time by means of continuously receiving electric signals by the receiving dipoles and drawing the curves of the apparent resistivities of the receiving dipoles, thereby improving the real-time performance of the advanced prediction results.

In order to verify the effectiveness of the above-mentioned method for advancedly detecting the water-bearing hazard body in real-time based on the vector resistivities, a simulation is conducted, and the specific simulation data are as follows.

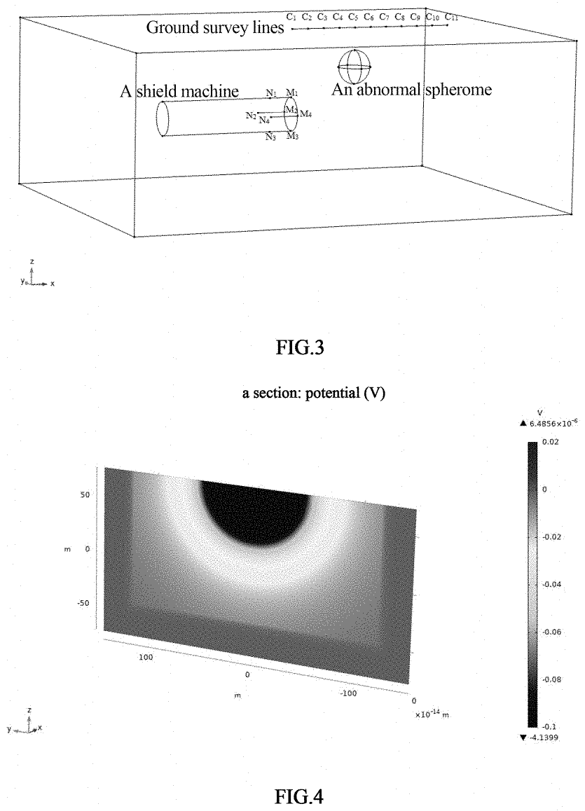

As a detection environment illustrated in FIG. 3, in the simulation, the abnormal body is set as a sphere with a radius of 5 m and a resistivity of 1 Ω·m; a resistivity of surrounding rocks is 100 Ω·m, and a resistivity of the tunnel is 10⁸ Ω·m. The situations that the low resistance sphere is located at different positions on the tunnel face, such as 15 m, 25 m and 30 m in the right front of the tunnel face, 15 m in the right-side front and 15 m in the left-side front of the tunnel face, 10 m in the upper-side front and 10 m in the lower-side front of the tunnel face, are conducted respectively.

The following curves of the apparent resistivities are drawn after absolute values of data are taken.

1. The distribution of a uniform half-space flow field: when the power supply dipole C2-C3 operates, the potential distribution of the half-space in the Y-Z section (x=0) is as illustrated in FIG. 4. By taking the potential data of the receiving electrode N4, potential attenuation (after taking the absolute values) of the receiving electrode N4 is drawn as illustrated in FIG. 5, which conforms to the potential attenuation law in the steady current field of the electric dipole source on the ground.

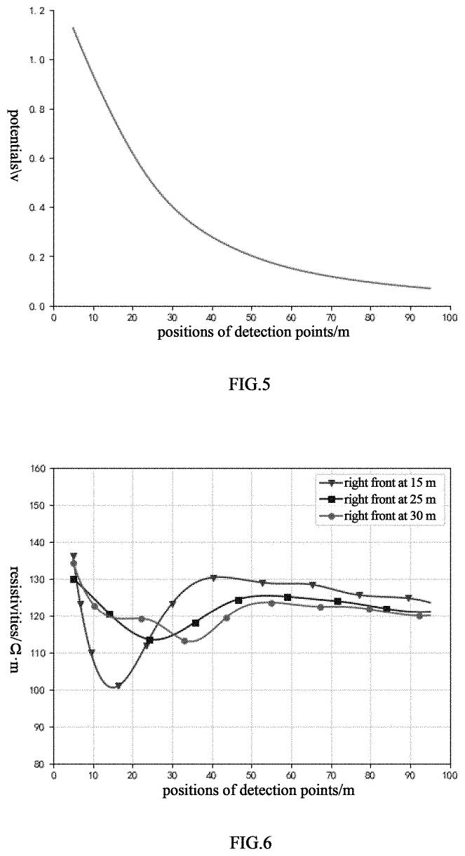

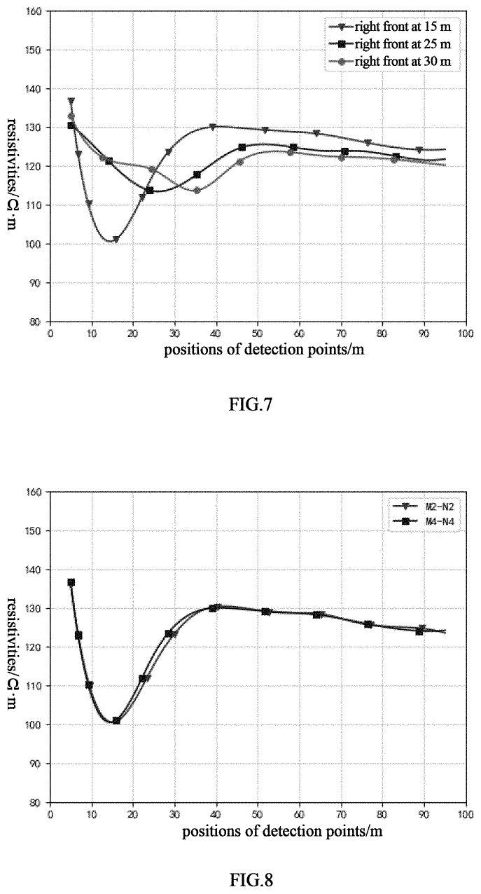

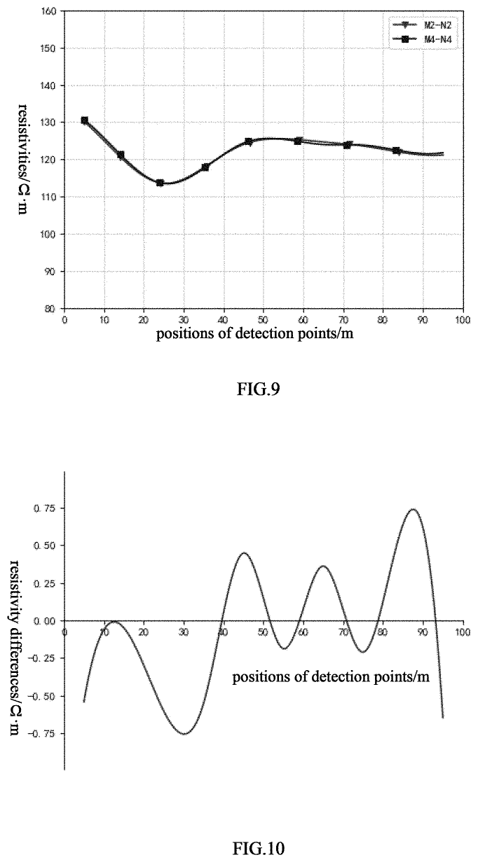

2. The positioning of the abnormal body in the front of the tunnel face in the tunneling direction of the shield machine: as illustrated in FIGS. 6 to 11, a minimum value occurs respectively on the curves of the apparent resistivities of the two groups of the receiving dipole M2-N2 and receiving dipole M4-N4, then an abnormal body is in front of the tunnel face, and a coordinate value a at the abscissa axis corresponding to a minimum point is the distance of the abnormal body in front of the tunnel face. On the basis of the abnormal body is in front of the tunnel face, when the apparent resistivity values of the receiving dipole M2-N2 and the receiving dipole M4-N4 on the same apparent resistivity curve are equal to each other, the abnormal body is located in the right front of the tunnel face, neither to the left nor to the right. Furthermore, when the curve of the differences between the apparent resistivity values for M2-N2 and M4-N4 is maintained to jump up and down at 0 Q·m and the amplitude does not exceed 1 Ω·m (that is, converges to 0 Q·m), the abnormal body is located right in front of the tunnel face, neither to the left nor to the right, and the determination is more direct and simple.

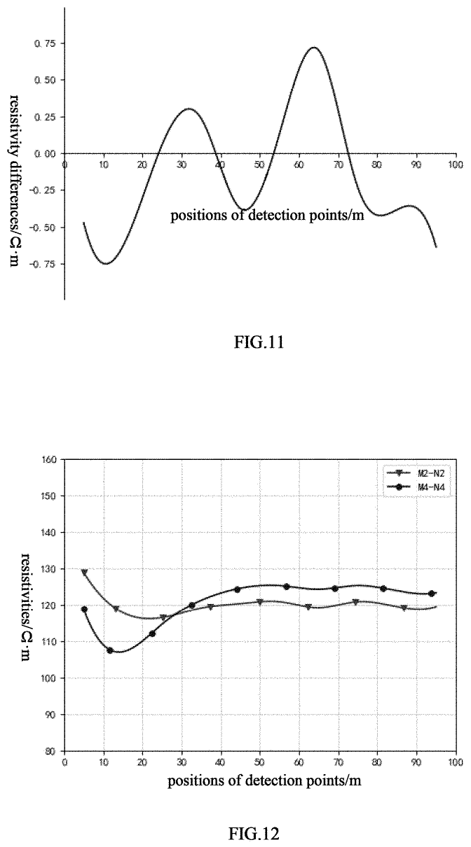

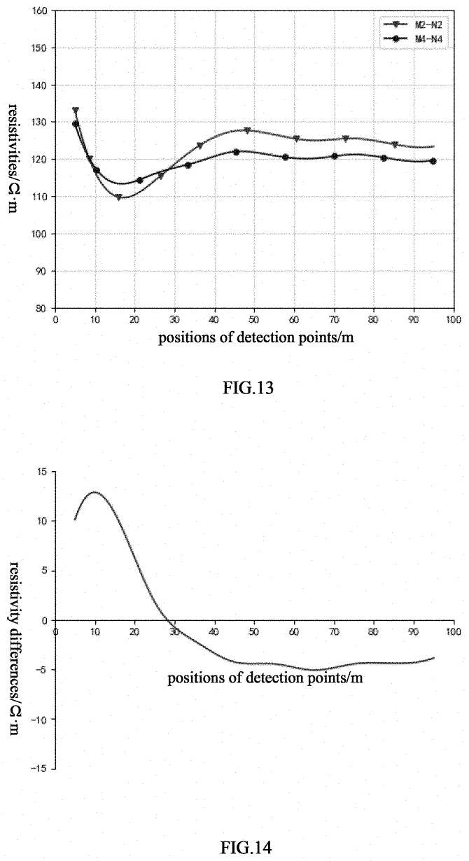

3. The positioning of the abnormal body at a lateral position: as illustrated in FIGS. 12 to 15, in the same apparent resistivity curve diagram, when the apparent resistivity value for M4-N4 of the first curve is less than the apparent resistivity value for M2-N2 of the first curve, that is, M4-N4 is located below M2-N2, then the abnormal body is located in the right-side front of the tunnel face; on the contrary, when the apparent resistivity value for M4-N4 of the first curve is greater than the apparent resistivity value for M2-N2 of the first curve, that is, M2-N2 is located below M4-N4, then the abnormal body is located in the left-side front of the tunnel face. Furthermore, when the curve of the difference between the apparent resistivity values of M2-N2 and M4-N4 shows the characteristic of “positive first and then negative”, the abnormal body is located in the right-side front of the tunnel face; when the curve of the difference between the apparent resistivity values of M2-N2 and M4-N4 shows the characteristic of “negative first and then positive”, the abnormal body is located in the left-side front of the tunnel face, and the determination is more direct and simple.

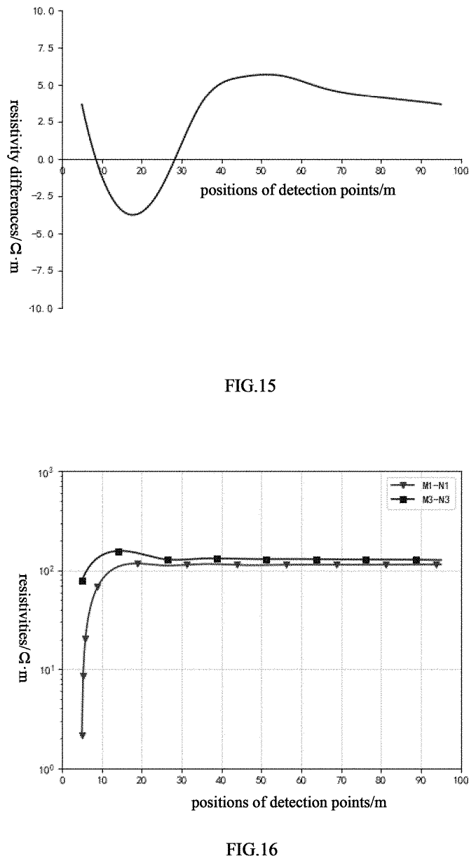

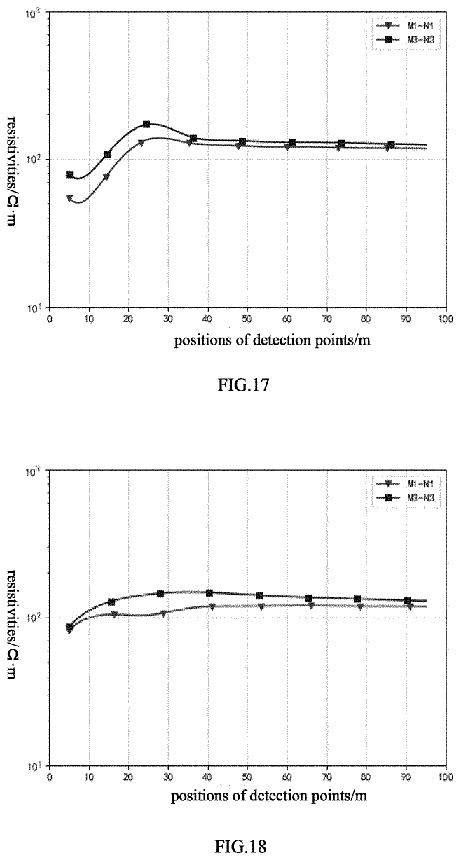

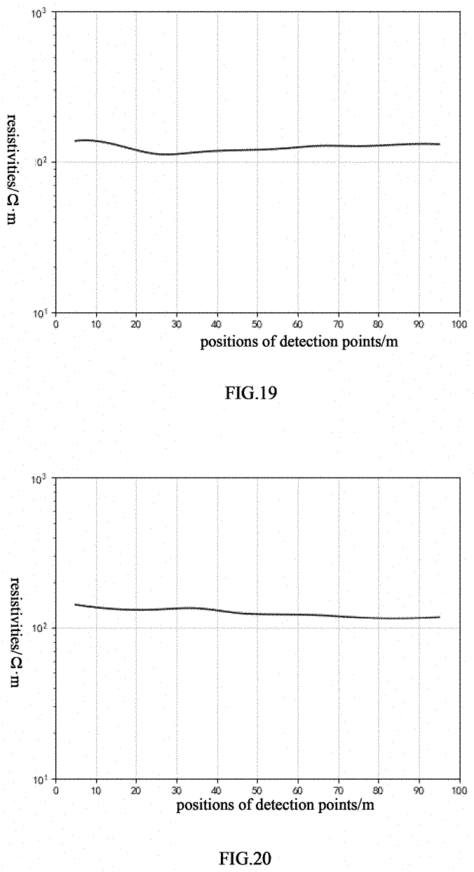

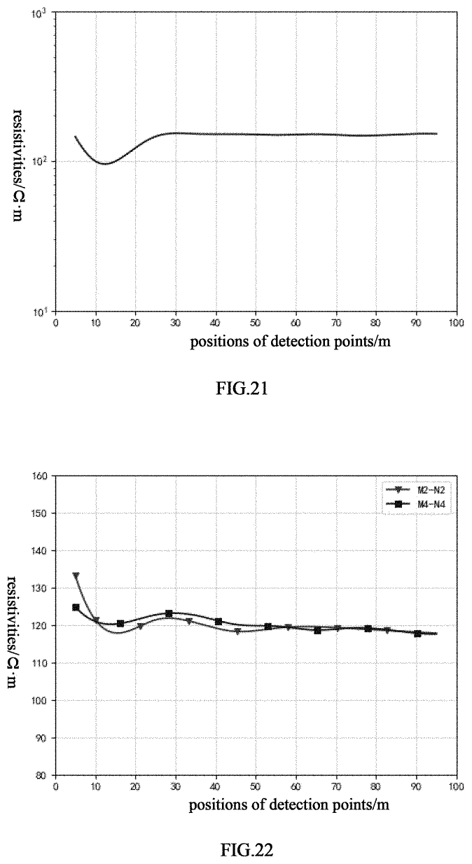

4. The positioning of the abnormal body at a longitudinal position: for a convenient comparison, as illustrated in FIGS. 16 to 21 (logarithmic coordinates are adopted), in the same apparent resistivity curve diagram, when the first curve formed by the curves of the apparent resistivity values of M1-N1 and M3-N3 shows the characteristic of “opening” and changes dramatically (a steep curve), the abnormal body is located in the lower-side front of the tunnel face; when the first curve formed by the curves of the apparent resistivity values of M1-N1 and M3-N3 shows the characteristic of “parallel”, the abnormal body is located in the upper-side front of the tunnel face; when the first curve formed by the curves of the apparent resistivity values of M1-N1 and M3-N3 shows the characteristic of “closed”, the abnormal body is located in the front of the tunnel face, neither to the upper nor to the lower, that is, in the right front of the the tunnel face. On this basis, especially for the position where the abnormal body is located in the upper-side front of the tunnel face, the curve of the apparent resistivity value of M1-M3 will have a minimum value at the first curve, which can be taken as the auxiliary parameter to determine that the abnormal body is located in the upper-side front of the tunnel face.

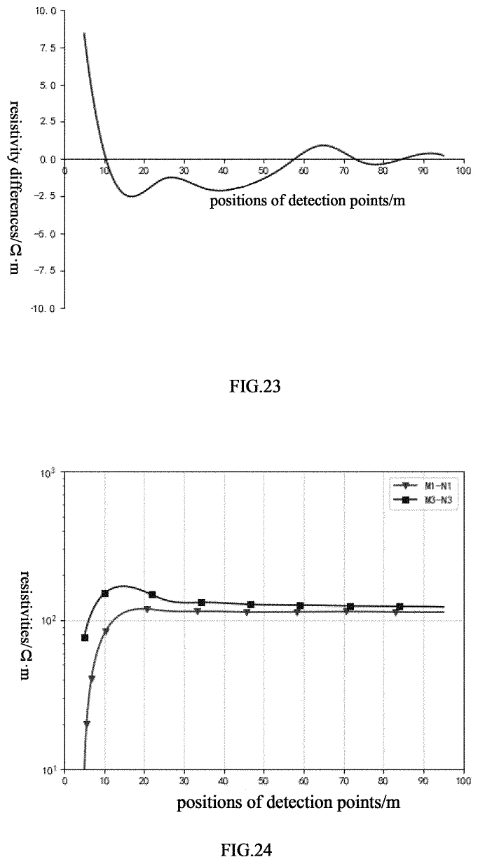

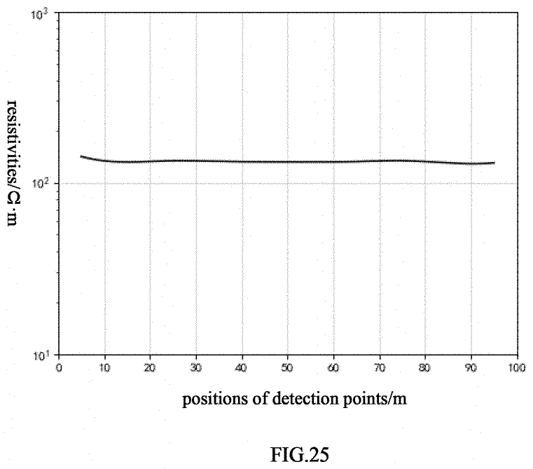

5. The positioning of the abnormal body at an arbitrary orientation within a space. A coordinate of the abnormal body is set as (15, −15, 50), and the radius is r=5 m, that is, the abnormal body is located at 15 m in front of the tunnel face, and an extension range is a sphere with a radius of 5 m within the space at a position of the lower right within the space, which is hereinafter referred to as a “specific position”. As illustrated in FIGS. 22 to 25, it can be seen that the abnormal characteristics are consistent with the actual location of the abnormal body; two curves of the apparent resistivities in FIG. 22 both have extreme values at x=15 m; the curve in FIG. 23 shows the characteristic of “positive first and then negative”; the first curve form by two curves in FIG. 24 is in the shape of a steeper “opening”. The illustration in FIG. 25 is consistent with the previous simulation results.

It should be understood that although the steps in the flowchart of FIG. 1 are shown sequentially as indicated by the arrows, these steps are not necessarily executed sequentially as indicated by the arrows. Unless explicitly stated in the present disclosure, there is no strict order restriction on the execution of these steps. These steps can be executed in other orders. Moreover, although at least a part of the steps in FIG. 1 can include a plurality of sub-steps or phases, these sub-steps or phases are not necessarily completed at the same time, but can be executed at different times. The execution order of these sub-steps or phases is not necessarily sequential, but can be executed alternately or alternately with other steps or at least a part of the sub-steps or phases of other steps.

The technical features in the above embodiments can be combined arbitrarily. In order to make the description concise, all possible combinations of the technical features in the above embodiments are not described, however, it should be considered as the scope of the description as long as there is no contradiction in the combination of these technical features.

The above embodiments only express a plurality of implementations in the present disclosure, and the descriptions of which are comparatively specific and detailed, but it should not be understood as a limitation on the scope of the present disclosure. It should be noted that for ordinary technicians in the art, some changes and improvements can be made without departing from the concept of the present disclosure, which are all within the protection scope of the present disclosure. Therefore, the protection scope of the present disclosure shall be subject to the appended claims.

What is claimed is:

1. A method for advancedly detecting a water-bearing hazard body in real-time based on vector resistivities, wherein the method comprises:
acquiring, based on a pre-constructed detection environment, potential differences of receiving dipoles on a shield machine in real-time, wherein the receiving dipoles include first receiving dipoles and a second receiving dipole;
performing, according to relative positional relationships between the receiving dipoles and power supply dipoles, and the potential differences of the receiving dipoles, resistivity conversion by using a formula for calculating resistivities in a steady current field to obtain the apparent resistivities of the receiving dipoles;
drawing, by taking positions of the power supply dipoles as an abscissa axis and the apparent resistivities as an ordinate axis, curves of the apparent resistivities of the receiving dipoles; and
analyzing the changing curves of the apparent resistivities, and determining a detection result of an abnormal body;
wherein a construction method of the detection environment is as follows:
arranging a plurality of power supply electrodes at a constant interval on a ground along a central axis of a tunnel in a direction of tunneling, and forming the power supply dipoles by combining each adjacent power supply electrodes pairwise;
arranging a preset number of first receiving electrodes, around the shield machine at a preset interval arc length, on a shield machine shell away from a cutterhead of the shield machine, and arranging a preset number of second receiving electrodes, around the shield machine at the preset interval arc length, on the shield machine shell proximate to the cutterhead of the shield machine, wherein each of the second receiving electrodes is correspondingly located on an extension line parallel to the shield machine shell in a direction from a location point of a first receiving electrode to the cutterhead of the shield machine;
forming the preset number of the first receiving dipoles by the first receiving electrodes and the second receiving electrodes on a same extension line, connecting position points, to each other, of the second receiving electrodes around the shield machine shell proximate to the cutterhead of the shield machine, and forming the second receiving dipole by two of the second receiving electrodes on a line segment passing through a central axis of the shield machine and perpendicular to the ground, wherein the first receiving electrodes and the second receiving electrodes are configured to collect electric signals in the tunnel, and obtain, according to the electric signals, the potential differences between the first receiving dipoles and the second receiving dipole in different orientations of the tunnel; and
supplying, along with a continuous underground tunneling of the shield machine, the power supply dipoles in turn to form the detection environment, so that the first receiving electrodes and the second receiving electrodes on the shield machine are capable of collecting the electrical signals.

2. The method according to claim 1, wherein the step of analyzing the changing curves of the apparent resistivities, and determining the detection result of the abnormal body, includes:
determining, according to whether a minimum value occurs in the changing curves of the apparent resistivities, that whether the abnormal body is detected or not; and
determining, when the abnormal body is detected, according to value comparison relationships of values of apparent resistivities and shapes of curves of apparent resistivities of the first receiving dipoles, and abnormal conditions of a curve of an apparent resistivity of the second receiving dipole, a location of the abnormal body.

3. The method according to claim 1, wherein the formula for calculating the resistivities in the steady current field is:
$${ρ}_{S} = k \frac{Δ {U}_{MN}}{I} ,$$
where ΔU_{MN} is a potential difference between a receiving electrode M and a receiving electrode N of a receiving dipole, ρ_{S} is an apparent resistivity of the receiving dipole, k is a pole distribution constant, I is a power supply current of a power supply dipole, M is a serial number of one receiving electrode of the receiving dipole, and N is a serial number of another receiving electrode of the receiving dipole.
